(19) United States
(12) Patent Application Publication
(10) Pub. No.: US 2006/0002548 A1
(43) Pub. Date: Jan. 5, 2006

(54) Method and system for implementing substitution boxes (S-boxes) for advanced encryption standard (AES)

(76) Inventor: Hon Fai Chu, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 10/933,702

(22) Filed: Sep. 2, 2004

Related U.S. Application Data
(60) Provisional application No. 60/577,368, filed on Jun. 4, 2004.

(51) Int. Cl. H04K 1/00

(52) U.S. Cl. 380/28

(57) ABSTRACT

Systems and methods for implementing Advanced Encryption Standard (AES) are disclosed herein. Aspects of the method may comprise storing 256 bytes of data. A non-zero byte portion of the 256 bytes of data may be replaced with multiplicative inverse bytes in a Galois field GF(256) and the replaced inverse bytes may be affine transformed over GF (2). The affine transformed bytes may be affine inverse transformed, and the affine inverse transformed bytes may be multiplicatively inversed over GF(256). The affine transformation over GF(2) may be determined as a matrix multiplication and addition of (1 1 0 0 0 1 1 0). If the 256 bytes comprise a zero byte, the zero byte from the 256 bytes of data may be mapped to the zero byte portion of the 256 bytes of data.

### CROSS-REFERENCE TO RELATED APPLICATIONS/INCORPORATION BY REFERENCE

This application makes reference to, claims priority to, and claims the benefit of U.S. Provisional Application Ser. No. 60/577,368 (Attorney Docket No. 15598US01) filed Jun. 4, 2004 and entitled “Standalone Hardware Accelerator For Advanced Encryption Standard (AES) Encryption And Decryption.”

This application makes reference to U.S. application Ser. No. ______ (Attorney Docket No. 15598US02) filed Sep. 2, 2004.

The above stated applications are hereby incorporated herein by reference in their entirety.

### FIELD OF THE INVENTION

Certain embodiments of the invention relate to protection of data. More specifically, certain embodiments of the invention relate to a method and system for implementing substitution boxes (S-boxes) for Advanced Encryption Standard (AES) encryption and decryption operations.

### BACKGROUND OF THE INVENTION

Current encryption standards include the DES and the 3DES encryption standards. Federal Information Processing Standards Publication (FIPS PUB) 197 was issued on Nov. 6, 2001 by the National Institute of Standards and Technology (NIST) introducing the Advanced Encryption Standard (AES). The AES specifies a FIPS-approved cyptographic algorithm, the Rijndael algorithm, that may be utilized to protect electronic data. FIPS PUB 197 is available electronically at http://csrc.nist.gov/publications/.

The Rijndael algorithm, which defines the AES, is a symmetric block encryption algorithm with variable block and key lengths. It can process blocks of 128, 192, and 256 bits and keys of the same length. Each block plain text is encrypted several times with a repeating sequence of operations, where each step in a sequence of operations is referred to as a round. The number of rounds is a function of the block and key lengths and may be illustrated by the following table:

| | Block Length (bits) | | |
|---|---|---|---|
| Key Length (bits) | 128 | 192 | 256 |
| 128 | 10 | 12 | 14 |
| 192 | 12 | 12 | 14 |
| 256 | 14 | 14 | 14 |

The AES algorithm may use cryptographic keys of 128, 192, and 256 bits to encrypt and decrypt data in blocks of 128. In addition, the AES algorithm may be implemented in software, firmware, hardware, or any combination thereof. However, the AES encryption/decryption standard requires significant processing capabilities for implementation, especially if the implementation is exclusively in software. For example, an important step of the AES Rijndael algorithm is data permutation, or Substitution-box (S-box) operation. During conventional AES encryption and decryption, data permutation by S-boxes needs to be performed every round for the total number of rounds as reflected in the table above. Moreover, S-box computation is required in key scheduling phases of the AES algorithm.

Conventional implementations of S-boxes utilize on-chip memory, which is not efficient for applications with limited memory access. As a result, significant processing loads may be placed on a digital signal processor (DSP), or another system processor, during operation of a device utilizing S-boxes utilized in accordance with the AES encryption/decryption standard. In this manner, the DSP, or another system processor, may become overloaded when processing S-box data permutations and other processing tasks required during AES encryption and decryption, thereby resulting in poor system performance. Furthermore, the simplified S-box implementation according to the AES standard in FIPS PUB 197 requires use of increased number of processing resources, which results in the increase of the AES processing circuit form factor and a decrease in the processing speed of application-specific integrated circuits (ASICs) used during AES encryption and decryption.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for implementing Advanced Encryption Standard (AES). Aspects of the method may comprise storing 256 bytes of data. A non-zero byte portion of the 256 bytes of data may be replaced with multiplicative inverse bytes in a Galois field GF(256) and the replaced inverse bytes may be affine transformed over GF (2). The affine transformed bytes may be affine inverse transformed, and the affine inverse transformed bytes may be multiplicatively inversed over GF(256). The affine transformation over GF(2) may be determined as a matrix multiplication and addition of (1 1 0 0 0 1 1 0). The matrix multiplication and addition may be implemented using the following equation:

$$\begin{matrix}y0 \\ y1 \\ y2 \\ y3 \\ y4 \\ y5 \\ y6 \\ y7\end{matrix} = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}x0 \\ x1 \\ x2 \\ x3 \\ x4 \\ x5 \\ x6 \\ x7\end{matrix} ] + [ \begin{matrix}1 \\ 1 \\ 0 \\ 0 \\ 0 \\ 1 \\ 1 \\ 0\end{matrix} ]$$

If the 256 bytes comprise a zero byte, the zero byte from the 256 bytes of data may be mapped to the zero byte portion of the 256 bytes of data. The non-zero byte portion of the 256 bytes may be replaced with multiplicative inverse bytes in the Galois field GF(256) utilizing a first order polynomial (bx+c) with coefficients from GF(16) in optimal normal basis. The multiplicative inverse bytes in GF(256) may be generated utilizing an irreducible second order polynomial (x²+Ax+B). The multiplicative inverse bytes in GF(256) may be generated utilizing a first order polynomial (bx+c) modulo the irreducible second order polynomial (x²+Ax+B). The first order polynomial (bx+c) modulo the irreducible second order polynomial (x²+Ax+B) may be generated using the following equation:
(bx+c)⁻¹=b(b²B+bcA+c²)⁻¹x+(c+bA)(b²B+bcA+c²)⁻¹.

A polynomial p(x)=x⁸+x⁴+x³+x²+1 in GF(256) may be mapped to a first order polynomial with coefficients of GF(16) in optimal normal basis (bx+c). The polynomial p(x)=x⁸+x⁴+x³+x²+1 in GF(256) may be mapped to the first order polynomial with coefficients of GF(16) in optimal normal basis (bx+c) utilizing the following matrices:

$${T}_{γ}^{α} = \begin{matrix}0 & 1 & 0 & 0 & 0 & 1 & 0 & 1 \\ 0 & 0 & 1 & 1 & 1 & 0 & 1 & 1 \\ 1 & 1 & 0 & 0 & 0 & 0 & 0 & 1 \\ 0 & 1 & 0 & 1 & 0 & 1 & 1 & 1 \\ 0 & 1 & 1 & 0 & 1 & 1 & 1 & 1 \\ 0 & 0 & 0 & 0 & 1 & 1 & 1 & 1 \\ 1 & 1 & 0 & 0 & 1 & 0 & 0 & 0\end{matrix} {T}_{α}^{γ} = \begin{matrix}1 & 0 & 0 & 0 & 1 & 1 & 1 & 1 \\ 1 & 1 & 1 & 1 & 1 & 1 & 1 & 0 \\ 1 & 1 & 1 & 1 & 0 & 0 & 1 & 0 \\ 1 & 0 & 0 & 1 & 1 & 0 & 0 & 1 \\ 0 & 1 & 1 & 1 & 0 & 0 & 1 & 1 \\ 0 & 0 & 1 & 0 & 1 & 1 & 1 & 1 \\ 0 & 0 & 0 & 0 & 1 & 0 & 0 & 1\end{matrix}$$

The polynomial p(x)=x⁸+x⁴+x³+x²+1 in GF(256) may be mapped utilizing the following look-up table:

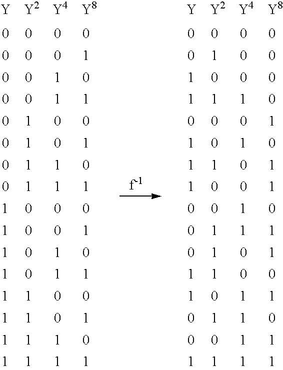

Another aspect of the invention may provide a machine-readable storage, having stored thereon, a computer program having at least one code section executable by a machine, thereby causing the machine to perform the steps as described above for implementing AES.

The system for implementing AES may comprise circuitry that stores 256 bytes of data. A non-zero byte portion of the 256 bytes of data may be replaced by the circuitry with multiplicative inverse bytes in a Galois field GF(256), and a portion of the replaced inverse bytes may be affine transformed by the circuitry over GF (2). The circuitry may affine inverse transform the affine transformed bytes and may multiplicatively inverse the affine inverse transformed bytes over GF(256). The affine transformation over GF(2) may be determined by the circuitry as a matrix multiplication and addition of (1 1 0 0 0 1 1 0). The matrix multiplication and addition may be implemented by the circuitry using the following equation:

$$\begin{matrix}y0 \\ y1 \\ y2 \\ y3 \\ y4 \\ y5 \\ y6 \\ y7\end{matrix} = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}x0 \\ x1 \\ x2 \\ x3 \\ x4 \\ x5 \\ x6 \\ x7\end{matrix} ] + [ \begin{matrix}1 \\ 1 \\ 0 \\ 0 \\ 0 \\ 1 \\ 1 \\ 0\end{matrix} ]$$

If the 256 bytes comprise a zero byte, the circuitry may map the zero byte from the 256 bytes to the zero byte portion of the 256 bytes of data. The non-zero byte portion of the 256 bytes may be replaced by the circuitry with multiplicative inverse bytes in GF(256) utilizing a first order polynomial (bx+c) with coefficients from GF(16) in optimal normal basis. The multiplicative inverse bytes in GF(256) may be generated by the circuitry utilizing an irreducible second order polynomial (x²+Ax+B). The multiplicative inverse bytes in GF(256) may be generated by the circuitry utilizing a first order polynomial (bx+c) modulo the irreducible second order polynomial (x²+Ax+B). The first order polynomial (bx+c) modulo said irreducible second order polynomial (x²+Ax+B) may be generated by the circuitry using the following equation:
(bx+c)⁻¹=b(b²B+bcA+c²)⁻¹x+(c+bA)(b²B+bcA+c²)⁻¹.

A polynomial p(x)=x⁸+x⁴+x³+x²+1 in GF(256) may be mapped by the circuitry to a first order polynomial with coefficients of GF(16) in optimal normal basis (bx+c). The polynomial p(x)=x⁸+x⁴+x³+x²+1 in GF(256) may be mapped by the circuitry to the first order polynomial with coefficients of GF(16) in optimal normal basis (bx+c) utilizing the following matrices:

$${T}_{γ}^{α} = \begin{matrix}0 & 1 & 0 & 0 & 0 & 1 & 0 & 1 \\ 0 & 0 & 1 & 1 & 1 & 0 & 1 & 1 \\ 1 & 1 & 0 & 0 & 0 & 0 & 0 & 1 \\ 0 & 1 & 0 & 1 & 0 & 1 & 1 & 1 \\ 0 & 1 & 1 & 0 & 1 & 1 & 1 & 1 \\ 0 & 0 & 0 & 0 & 1 & 1 & 1 & 1 \\ 1 & 1 & 0 & 0 & 1 & 0 & 0 & 0\end{matrix} {T}_{α}^{γ} = \begin{matrix}1 & 0 & 0 & 0 & 1 & 1 & 1 & 1 \\ 1 & 1 & 1 & 1 & 1 & 1 & 1 & 0 \\ 1 & 1 & 1 & 1 & 0 & 0 & 1 & 0 \\ 1 & 0 & 0 & 1 & 1 & 0 & 0 & 1 \\ 0 & 1 & 1 & 1 & 0 & 0 & 1 & 1 \\ 0 & 0 & 1 & 0 & 1 & 1 & 1 & 1 \\ 0 & 0 & 0 & 0 & 1 & 0 & 0 & 1\end{matrix}$$

The polynomial p(x)=x⁸+x⁴+x³+x²+1 in GF(256) may be mapped by the circuitry utilizing the following look-up table:

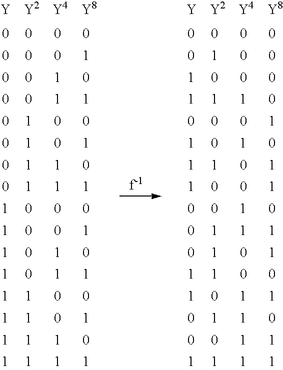

These and other advantages, aspects and novel features of the present invention, as well as details of an illustrated embodiment thereof, will be more fully understood from the following description and drawings.

[symbol]

### BRIEF DESCRIPTION OF SEVERAL VIEWS OF THE DRAWINGS

FIG. 1A is a block diagram of an exemplary hardware accelerator for Advanced Encryption Standard (AES) encryption and decryption, in accordance with an embodiment of the invention.

FIG. 1B is a block diagram of an exemplary AES algorithm processing sequence that may be utilized in accordance with an embodiment of the invention.

FIG. 2 is a functional diagram of an exemplary Galois Field (GF) 16-bit first order polynomial inversion that may be utilized in accordance with an embodiment of the invention.

FIG. 3 is a block diagram of an exemplary S-box implementation, in accordance with an embodiment of the invention.

FIG. 4 is a flow diagram of a exemplary method for implementing an S-box, in accordance with an embodiment of the invention.

FIG. 5 is a block diagram of a system for AES encryption and decryption utilizing S-boxes, in accordance with an embodiment of the invention.

### DETAILED DESCRIPTION OF THE INVENTION

Certain aspects of the invention may be found in a method and system for implementing AES. The byte substitution functionality of an S-box may be significantly improved by implementing the S-box for byte substitution utilizing mathematical equations, rather than a look-up table as provided in the conventional AES/Rijndael algorithm. Such S-box implementation may be utilized, for example, in resource constrained applications where a look-up table or ROM approaches are not feasible. Since the S-box transformation is a critical computational process in the AES algorithm, it may be utilized for both encryption and decryption. The S-box, therefore, may be implemented as an invertible S-box that may be used for encryption and decryption. In one aspect of the invention, mathematical equations may be utilized to efficiently perform byte transformations as required by the AES algorithm, resulting in optimal circuit performance for cost and performance sensitive communication chipsets, such as mobile chipsets.

An implementation of the AES encryption/decryption standard may utilize a 128, 192 or 256-bit key to encrypt or decrypt a 128-bit data block. The AES Rijndael algorithm utilizes four different byte-oriented transformations, which include byte substitution using a substitution table, or one or more S-boxes; shifting rows within a data block by different offsets; mixing the data within each column of a data block; and adding a round key to a data block. A plurality of round keys may be calculated utilizing an initial encryption/decryption key according to various key expansion routines, for example. A round key may be 128 bits.

By exploiting the mathematical properties of S-box implementation equations, encryption and decryption S-boxes may be implemented with a very high rate of resource reuse. For example, approximately 75% area saving may be achieved on S-box implementation according to the invention versus a conventional S-box look-up table implementation. Also, significant speed performance enhancement for encryption and decryption may be achieved by exploiting a single-pipelined stage at the middle of the transformation steps, which may be hard to accomplish with the conventional look-up table implementation. For example, approximately 25% enhancement in processing speed may be achieved as the complex computational load may be distributed between a front and rear pipeline.

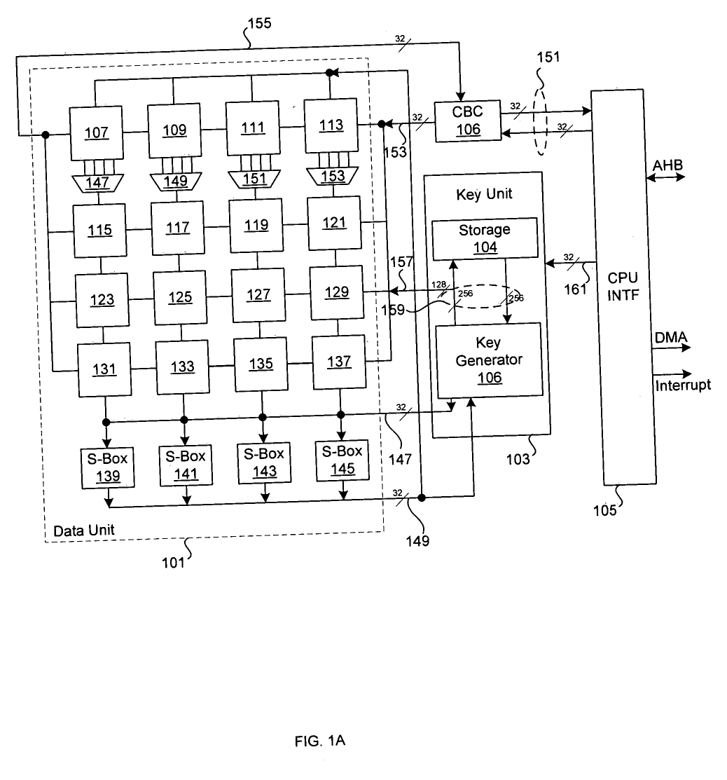

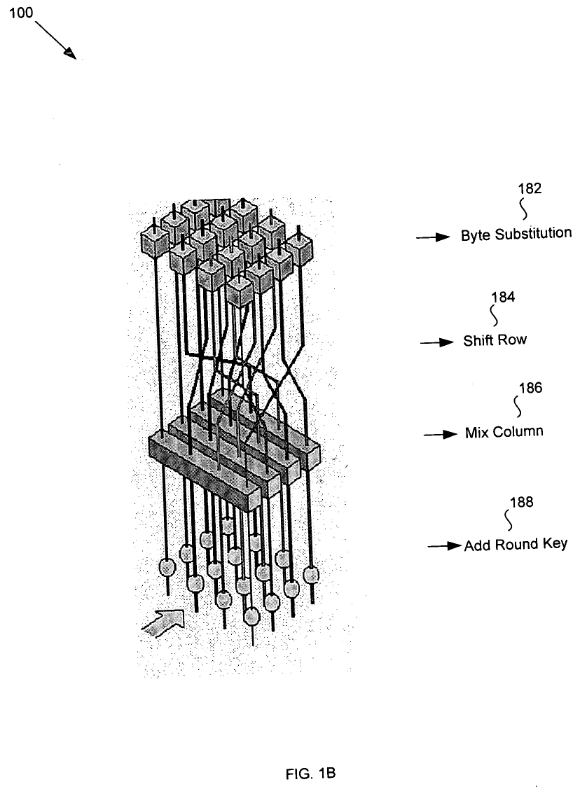

FIG. 1A is a block diagram of an exemplary hardware accelerator for Advanced Encryption Standard (AES) encryption and decryption, in accordance with an embodiment of the invention. Referring to FIG. 1, the exemplary hardware accelerator 100 may comprise a data unit 101, a key unit 103, a chain block ciphering (CBC) unit 106, and a CPU interface 105.

The data unit 101 may comprise a plurality of registers such as sixteen 8-bit registers, 107 through 137, multiplexers 147, 149, 151, and 153, and S-boxes 139, 141, 143, and 145. The sixteen 8-bit registers 107 through 137 may be adapted to store a total of eight bytes, or 128 bits for example. In this way, the data unit 101 may store a 128-bit input data block at one time, as required by the Rijndael algorithm of the AES encryption/decryption standard. The data unit 101 may be adapted to implement the four byte-oriented transformations of the AES encryption/decryption standard: byte substitution using a substitution table, or an S-box; shifting rows within a data block by different offsets; mixing the data within each column of a data block; and adding a round key to a data block.

The multiplexers 147, 149, 151, and 153 may be coupled to the first and second row of registers 107 through 113 and 115 through 121, respectively. The multiplexers 147, 149, 151, and 153 may comprise suitable circuitry, logic and/or code and may be adapted to perform the row shifting transformation of the AES encryption/decryption standard. More specifically, data within the sixteen 8-bit registers 107 through 137 may be cyclically shifted over different numbers of bytes, or offsets, utilizing the multiplexers 147, 149, 151, and 153. In one aspect of the invention, the last three rows of the 128-bit data block within the data unit 101 may be cyclically shifted so that different numbers of bytes may be shifted to lower positions within the data block rows. After a row is shifted down in the data unit 101, it may be substituted by the S-boxes 139, 141, 143, and 145.

The S-boxes 139, 141, 143, and 145 may comprise suitable circuitry, logic and/or code and may be adapted to perform byte substitution transformation of the AES encryption/decryption standard. The S-boxes 139, 141, 143, and 145 may utilize a Galois Field (GF) inversion followed by a Fourier transformation, or an affine transformation. The GF inversion and the affine transformation may be realized by using polynomial operations as outlined in the AES encryption/decryption standard. In one aspect of the invention, a data unit 101 may comprise a reduced number of S-boxes, so that several S-boxes may perform substitution transformations for all 128-bits within the data unit 101. For example, S-boxes 139, 141, 143, and 145 may be utilized for substitution transformation for one data row, or 32 bits, at a time. After the S-boxes 139, 141, 143, and 145 have performed substitution, the data unit 101 may utilize the multiplexers 147, 149, 151, and 153 to shift data down so that a new row may be transformed by the S-boxes 139, 141, 143, and 145. The reduced number of S-boxes may be utilized by the data unit 101 for time multiplexing different functions necessary for the implementation of the AES encryption/decryption standard.

The CBC unit 106 may comprise suitable circuitry, logic and/or code and may be adapted to exchange encrypted and decrypted information between the CPU interface 105 and the data unit 101. The CBC 106 may utilize 32-bit wide bus connections 151 to send and receive encrypted/decrypted data words to and from the CPU interface 105. In addition, the CBC 106 may communicate 32-bit word data words to the data unit 101 via the 32-bit wide bus 153 and may receive encrypted/decrypted information back from the data unit 101 via the 32-bit wide bus 155. The CBC 106 may also be adapted to utilize an original encryption key and a first encrypted message to obtain a second encryption key. In another embodiment of the invention, the CBC 106 may be utilized in an electronic code book (ECB) mode. The ECB mode may be utilized for a one-time encryption of a message by utilizing a single encryption key. When this occurs, any subsequent encryption of additional data may require a new encryption key.

The CPU interface 105 may be adapted to interface with a main processor (CPU). For example, the CPU interface 105 may generate DMA and/or interrupt commands to communicate with a CPU or other processor. In addition, a CPU via the CPU interface 105 may provide an initial encryption key to the key unit 103 via the 32-bit bus 161. The CPU interface 105 may provide unencrypted information to the CBC 106 and, in return, may receive encrypted information from the CBC 106 via the 32-bit bus connections 151.

The key unit 103 may comprise a storage module 104 and a key generator unit 106. The key generator unit 106 may comprise suitable circuitry, logic and/or code and may be adapted to generate 128-bit round keys from an initial encryption key. For example, the key generator unit may be adapted to generate a set of round keys that may be utilized during 10, 12 or 14 rounds of encryption of one 128-bit data block, depending on whether the hardware accelerator 100 utilizes a 128, 192 or a 256-bit encryption key, respectively. Encryption round keys generated by the key generator 106 may be stored in the storage unit 104 and may be utilized during subsequent encryption and/or decryption operations. The storage unit 104 and the key generator 106 are coupled via the 256-bit wide bus connections 159. In addition, a 128-bit wide bus connection 157 may be utilized for communicating a round key from the key unit 103 to the data unit 101.

In operation, an initial data word may be communicated from the CPU interface 105 to the CBC 106 via the bus connection 151 and then to the data unit 101 via the bus connection 153. An initial encryption key may be communicated from the CPU interface 105 to the key unit 103 via the bus connection 161. The key unit 103 may communicate the encryption key to the data unit 101 via the bus connection 157. After the data unit 101 receives an encryption or a decryption key from the key unit 103, the four byte-oriented transformations—byte substitution, shifting rows within a data block, mixing data within each column of a data block, and adding a round key to a data block—may be performed within the data unit 101. For each encryption/decryption round, the key generator 106 may be adapted to generate each round key “on the fly.” In this way, the key generator 106 may generate a round key and store it in the storage unit 104.

After the round key is utilized by the data unit 101, the key generator 106 may recall the stored round key from the storage unit 104 and may utilize it to generate a new round key for the subsequent encryption/decryption round. A new round key may be generated by the key generator 106 by utilizing a key expansion routine, for example. During a key expansion routine, the key generator 106 may communicate, via the bus connection 147, a generated encryption/decryption round key to the S-boxes 139, 141, 143 and 145 for byte substitution. The S-boxes 139, 141, 143 and 145 may return a processed round key, or a subword, back to the key generator 106 via the 32-bit bus 149. By utilizing “on the fly” round key generation in the key unit 103 and by time multiplexing the S-boxes 139, 141, 143 and 145 between the key generator 106 and the 8-bit registers within the data unit 101, on-chip resources may be better utilized and signal processing performance within the hardware accelerator 100 may be increased.

FIG. 1B is a block diagram 100 of an exemplary AES algorithm processing sequence that may be utilized in accordance with an embodiment of the invention. Referring to FIG. 1B, there is shown byte substitution 182, shift row permutation 184, mix column diffusion 186 and round key addition 188. In order to encrypt a block of data in accordance with the AES algorithm, the following sequence of operations may be applied: (1) a first round key is XOR-ed with the data block; (2) a determined number of regular rounds is executed; and (3) a terminal round is applied, where a particular operation, such as column mixing, may be omitted. Referring to FIG. 1, there is illustrated a processing sequence for an AES regular round. Each regular round of step 2 above may comprise the following operations:
1. Byte Substitution 182: Each byte of a block may be replaced by an application of one or more S-boxes;
2. Shift Row Permutation 184: Bytes of the block may be permutated in a ShiftRow transformation;
3. Mix Column Diffusion 186: MixColumn transformation may be executed on a block of bytes; and
4. Round Key Addition 188: The current round key is XOR-ed with the block.

Each of the above transformations may be considered as layers, where each layer may perform a key function within a round. The operation and significance of the layers may be characterized as follows:
1 Key influence layer: XOR-ing with the round key before the first round and at the last step within each round may affect every bit of the round result.
2 Nonlinear layer: S-box substitution is a non-linear operation. The S-box data operation may provides protection against differential and linear cryptanalysis.
3 Linear layer: ShiftRow and MixColumn operations ensure that the bits are mixed in an optimal fashion.

In one aspect of the invention, an S-box may be implemented and adapted to replace each byte of a data block by another value in any given encryption/decryption round. An S-box may comprise a list of 256 bytes. Each non-zero byte during substitution may be considered as belonging to the Galois field GF(2⁸). For encryption, the non-zero byte may then be replaced with its multiplicative inverse, where a multiplicative inverse of a zero byte is zero. An affine transformation over GF(2) may then be applied, where the affine transformation may be calculated as a matrix multiplication and addition of (1 1 0 0 0 1 1 0). For decryption, the S-box processing sequence may be applied in reverse. In this manner, the S-box may be utilized for affine inverse transformation followed by multiplicative inversion in GF(2⁸). The affine transformation may be represented in matrix form as:

$$\begin{matrix}y0 \\ y1 \\ y2 \\ y3 \\ y4 \\ y5 \\ y6 \\ y7\end{matrix} = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}x0 \\ x1 \\ x2 \\ x3 \\ x4 \\ x5 \\ x6 \\ x7\end{matrix} ] + [ \begin{matrix}1 \\ 1 \\ 0 \\ 0 \\ 0 \\ 1 \\ 1 \\ 0\end{matrix} ]$$

The S-box data computation, therefore, may comprise the following two steps: (1) multiplicative inversion, where a multiplicative inverse of each byte is taken in GF(2⁸) with any zero byte being mapped to itself; and (2) affine transformation performed in GF(2). The addition of the eight-tuple (1 1 0 0 0 1 1 0), which corresponds to hexadecimal value ‘0x63,’ may be incorporated in the key scheduling portion of the AES algorithm.

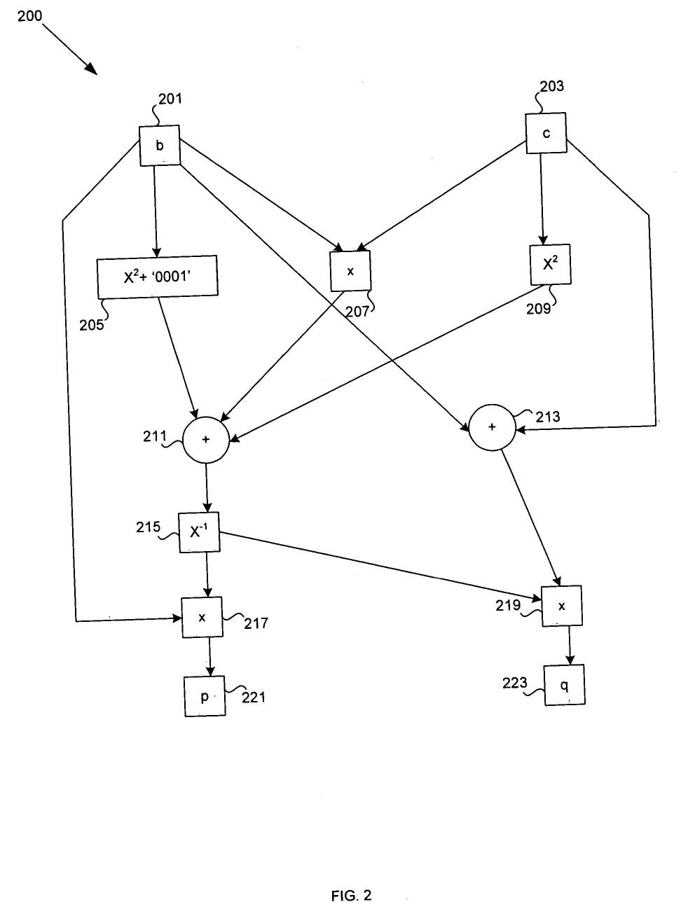

FIG. 2 is a functional diagram 200 of an exemplary Galois Field (GF) 16-bit first order polynomial inversion that may be utilized in accordance with an embodiment of the invention. Referring to FIG. 2, the polynomial inversion illustrated in the functional diagram 200 may be achieved in an S-box implemented in accordance with the invention. During an encryption process, an S-box may be utilized for inversion of a 256-bit Galois Field, GF(256). Affine transformation may then be performed after a GF(256) inversion. During a decryption process, an inverse affine transformation may be initially performed followed by a GF(256) inversion.

In one aspect of the invention, an S-box may be adapted to perform the GF(256) inversion by utilizing a 16-bit Galois Field, GF(16), inversion. A GF(256) inversion may be performed in the following order:
GF(256)→first order polynomial in GF(16) with optimal normal basis→GF(16) inversion of the first order polynomial→GF(256)
   A GF(256) may first be transformed to a GF(16) with optimal normal basis. GF(16) inversion may then be accomplished, followed by a transformation back into a GF(256). The GF(256) inversion process may utilize the following equation (1):
   (bx+c)⁻¹=b(b²B+bcA+c²)⁻¹x+(c+bA)(b²B+bcA+c²)⁻¹ (1)
   In the above equation (1), A may be selected to be multiplicative identity and B may be selected as a 4-bit vector ‘0001’ representing minimum Hamming weight. In this way, A and B may be optimized for GF(16) as Massey-Omura multipliers.

Referring again to FIG. 2, the GF(16) optimal normal basis transformation may be achieved by utilizing a first order polynomial (bx+c). The subsequent GF(16) inversion may be represented by a new polynomial (px+q). The functional diagram 200 illustrates an exemplary transformation of coefficients b 201 and c 203, representing the first order polynomial (bx+c), into the coefficients p 221 and q 223. During this transformation, multiplication operators 207, 217 and 219 may be utilized, together with addition operators 211 and 213. The vector addition operator 205 may be achieved by adding a 4-bit vector ‘0001’ to x². Operator 209 may be represented by squaring the indeterminate x in a 16-bit Galois Field. The calculations reflected on FIG. 2 may be performed in the GF(16). The inverse value operator 215 may be obtained from a look-up table, for example. A look-up table may be generated so that it is compliant with the AES encryption/decryption specification.

In accordance with the Rijndael algorithm in the AES encryption/decryption specification, GF(256) inversion may be performed by utilizing the polynomial m(x)=x⁸+x⁴+x³+x+1. In accordance with an aspect of the invention, GF(256) inversion may be performed utilizing the following operations.

Initially, the basis in m(x) may be changed to p(x)=x⁸+x⁴+x³+x²+1, which is a primitive irreducible polynomial. The following operations may be performed:
Let β=α^{k}, m(β)=α⁸k+α^{4k}+α^{3k}+α^{k}+1=0

For k=25,

$$\{ 1 , β , {β}^{2} , {β}^{3} , {β}^{4} , {β}^{5} , {β}^{6} , {β}^{7} \} -> \{ 1 , {α}^{25} , {α}^{50} , {α}^{75} , {α}^{100} , {α}^{125} , {α}^{150} , {α}^{175} \}$$

$$\begin{matrix}α = {T}_{β}^{α} β \{ \begin{matrix}α - \{ {α}_{0} , {α}_{1} , {α}_{2} , {α}_{3} , {α}_{4} , {α}_{5} , {α}_{6} , {α}_{7} \} \\ β - \{ {β}_{0} , {β}_{1} , {β}_{2} , {β}_{3} , {β}_{4} , {β}_{5} , {β}_{6} , {β}_{7} \}\end{matrix} \\ T = \begin{matrix}1 & 1 & 1 & 1 & 1 & 1 & 1 & 1 \\ 0 & 1 & 0 & 1 & 0 & 1 & 0 & 1 \\ 0 & 0 & 1 & 1 & 0 & 0 & 1 & 1 \\ 0 & 0 & 0 & 1 & 0 & 0 & 0 & 1 \\ 0 & 0 & 0 & 0 & 1 & 1 & 1 & 1 \\ 0 & 0 & 0 & 0 & 0 & 1 & 0 & 1 \\ 0 & 0 & 0 & 0 & 0 & 0 & 1 & 1 \\ 0 & 0 & 0 & 0 & 0 & 0 & 0 & 1\end{matrix} \\ {T}^{- 1} = T also .\end{matrix}$$

Subsequently, GF(256) on p(x) may be transformed to (bx+c) on GF(16). The following operations may be performed:
Let λ=αⁱ x²+Ax+B=(x+λ)(x+λ¹⁶)

$$\begin{matrix}A = 1 -> λ + {λ}^{16} = 1 \\ B = 0001 -> γ = λ \cdot {λ}^{16} \\ O . N . B . -> {γ}^{5} = 1 \\ ⇒ i = 111 \\ λ = {α}^{111} , γ = {λ}^{17} = {α}^{102}\end{matrix} \}$$

$$\{ γ , {γ}^{2} , {γ}^{6} , {γ}^{8} , γλ , {γ}^{2} λ , {γ}^{4} λ , {γ}^{8} λ \} -> \{ {α}^{102} , {α}^{204} , {α}^{153} , {α}^{51} , {α}^{213} , {α}^{60} , {α}^{8} , {α}^{162} \}$$

$$\begin{matrix}α = {T}_{γ}^{α} γ \\ {T}_{γ}^{α} = \begin{matrix}0 & 1 & 0 & 0 & 0 & 1 & 0 & 1 \\ 0 & 0 & 1 & 1 & 1 & 0 & 1 & 1 \\ 1 & 1 & 0 & 0 & 0 & 0 & 0 & 1 \\ 0 & 1 & 0 & 1 & 0 & 1 & 1 & 1 \\ 0 & 1 & 1 & 0 & 1 & 1 & 1 & 1 \\ 0 & 0 & 0 & 0 & 1 & 1 & 1 & 1 \\ 1 & 1 & 0 & 0 & 1 & 0 & 0 & 0\end{matrix} {T}_{α}^{γ} = \begin{matrix}1 & 0 & 0 & 0 & 1 & 1 & 1 & 1 \\ 1 & 1 & 1 & 1 & 1 & 1 & 1 & 0 \\ 1 & 1 & 1 & 1 & 0 & 0 & 1 & 0 \\ 1 & 0 & 0 & 1 & 1 & 0 & 0 & 1 \\ 0 & 1 & 1 & 1 & 0 & 0 & 1 & 1 \\ 0 & 0 & 1 & 0 & 1 & 1 & 1 & 1 \\ 0 & 0 & 0 & 0 & 1 & 0 & 0 & 1\end{matrix}\end{matrix}$$

GF(256)=m(x) may be transformed to GF(16) first order polynomial with optimal normal basis (ONB) by performing the following operations:

$$\{ 1 , β , {β}^{2} , {β}^{3} , {β}^{4} , {β}^{5} , {β}^{6} , {β}^{7} \} ↔ \{ γ , {γ}^{2} , {γ}^{4} {γ}^{8} , γ λ , {γ}^{2} λ , {γ}^{4} λ , {γ}^{8} λ \}$$

$$\begin{matrix}γ = {T}_{β}^{γ} β = {( {T}_{γ}^{α} )}^{- 1} {T}_{β}^{α} β ; β = {T}_{γ}^{β} γ = {T}_{β}^{α} {T}_{γ}^{α} γ \\ {T}_{β}^{γ} = \begin{matrix}1 & 1 & 1 & 1 & 0 & 1 & 1 & 1 \\ 1 & 0 & 0 & 0 & 0 & 0 & 0 & 1 \\ 1 & 0 & 0 & 0 & 1 & 0 & 1 & 1 \\ 1 & 1 & 1 & 0 & 0 & 0 & 0 & 0 \\ 0 & 1 & 1 & 1 & 0 & 1 & 0 & 1 \\ 0 & 0 & 1 & 1 & 1 & 0 & 1 & 1 \\ 0 & 0 & 0 & 0 & 1 & 1 & 1 & 0 \\ 0 & 1 & 0 & 0 & 0 & 1 & 0 & 1\end{matrix} : {T}_{γ}^{β} = \begin{matrix}0 & 0 & 1 & 0 & 1 & 1 & 0 & 1 \\ 0 & 0 & 0 & 0 & 1 & 1 & 1 & 0 \\ 0 & 0 & 1 & 1 & 0 & 0 & 1 & 1 \\ 0 & 0 & 1 & 1 & 1 & 0 & 1 & 0 \\ 1 & 1 & 0 & 0 & 0 & 1 & 0 & 1 \\ 0 & 1 & 1 & 0 & 0 & 0 & 1 & 0 \\ 1 & 0 & 1 & 0 & 0 & 1 & 0 & 1 \\ 0 & 1 & 1 & 0 & 1 & 1 & 0 & 1\end{matrix}\end{matrix}$$

For encryption, a 256-bit Galois Field, GF(256), may be transformed to GF(16), followed by an affine transformation. For decryption, an inverse affine transformation may be initially performed followed by a GF(256) inversion. The following vectors may be utilized during encryption and decryption:

| | |
|---|---|
| 8 Bit Vector | 8 Bit Vector |

Affine/Inv-affine

| ${b}^{′} = \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} b ⊕$ | 1 1 0 0 0 1 1 0 | ; | $b = \begin{matrix}0 & 0 & 1 & 0 & 0 & 1 & 0 & 1 \\ 1 & 0 & 0 & 1 & 0 & 0 & 1 & 0 \\ 0 & 1 & 0 & 0 & 1 & 0 & 0 & 1 \\ 1 & 0 & 1 & 0 & 0 & 1 & 0 & 0 \\ 0 & 1 & 0 & 1 & 0 & 0 & 1 & 0 \\ 0 & 0 & 1 & 0 & 1 & 0 & 0 & 1 \\ 1 & 0 & 0 & 1 & 0 & 1 & 0 & 0 \\ 0 & 1 & 0 & 0 & 1 & 0 & 1 & 0\end{matrix} {b}^{′} ⊕$ | 1 0 1 0 0 0 0 0 |
|---|---|---|---|---|
| Inv-affine/256 → 16 | | | 16 → 256/Affine | |
| $0 = \begin{matrix}1 & 0 & 1 & 0 & 1 & 1 & 0 & 1 \\ 0 & 1 & 1 & 0 & 1 & 1 & 1 & 1 \\ 1 & 0 & 1 & 0 & 1 & 0 & 0 & 1 \\ 1 & 1 & 1 & 1 & 1 & 1 & 1 & 0 \\ 0 & 0 & 0 & 1 & 1 & 1 & 0 & 0 \\ 0 & 1 & 1 & 0 & 0 & 0 & 0 & 1 \\ 1 & 1 & 1 & 0 & 1 & 1 & 1 & 1 \\ 1 & 1 & 1 & 1 & 0 & 0 & 0 & 1\end{matrix} i ⊕$ | 0 1 1 0 1 1 0 0 | ; | $0 = \begin{matrix}0 & 1 & 0 & 0 & 0 & 0 & 1 & 0 \\ 1 & 0 & 0 & 0 & 1 & 0 & 0 & 1 \\ 1 & 1 & 0 & 1 & 1 & 0 & 0 & 0 \\ 0 & 1 & 0 & 0 & 0 & 1 & 1 & 1 \\ 1 & 1 & 1 & 0 & 1 & 1 & 1 & 1 \\ 1 & 0 & 1 & 0 & 0 & 0 & 0 & 0 \\ 0 & 0 & 0 & 0 & 1 & 0 & 1 & 1 \\ 0 & 1 & 0 & 1 & 0 & 1 & 0 & 1\end{matrix} i ⊕$ | 1 1 0 0 0 1 1 0 |

The 8-bit vectors utilized in the above calculations may be obtained from the AES encryption/decryption standard. GF(16) transformation with ONB and GF(16) multiplication may be performed utilizing, for example, a Massey-Omura Parallel Multiplier, as follows:
d=(bx^{t})(cα^{t})^{t}=bMc^{t}

$$M = {α}^{t} α = [ \begin{matrix}{α}^{2} & {α}^{3} & {α}^{5} & {α}^{9} \\ {α}^{3} & {α}^{4} & {α}^{6} & {α}^{10} \\ {α}^{5} & {α}^{6} & {α}^{8} & {α}^{12} \\ {α}^{9} & {α}^{10} & {α}^{12} & α\end{matrix} ] = [ \begin{matrix}0 & 0 & 1 & 0 \\ 0 & 0 & 1 & 1 \\ 1 & 1 & 0 & 0 \\ 0 & 1 & 0 & 1\end{matrix} ] ⇐ \begin{matrix}{α}^{5} = 1 \\ {α}^{6} = α \\ {α}^{10} = {α}^{5}\end{matrix}$$

An exemplary multiplicative inversion table for GF(16) may be represented by the following matrices, where f⁻¹ represents the corresponding matrix. The multiplicative inversion table may be implemented as a look-up table.

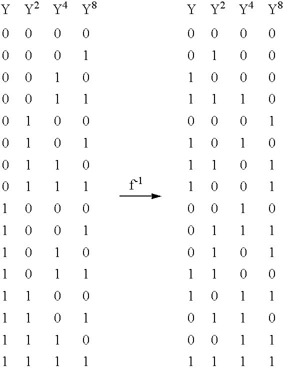

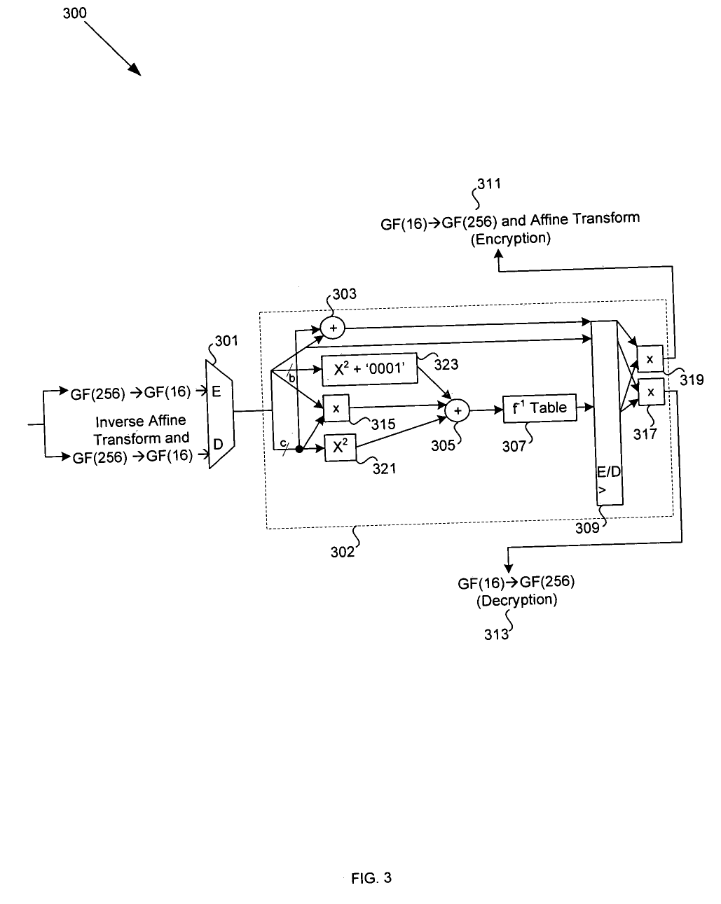

FIG. 3 is a block diagram of an exemplary S-box implementation, in accordance with an embodiment of the invention. Referring to FIG. 3, the S-box implementation 300 may comprise a multiplexer 301 and a GF(16) inversion logic 302. The GF(16) inversion logic 302 may comprise GF(16) operations 303, 307, 315, 317, 319, 321 and 323, and a register 309. The GF(16) operations 303, 307, 315, 317, 319, 321 and 323 may be the same GF(16) operations reflected in FIG. 2 and may be utilized for the GF(16) inversion transformation. For example, the GF(16) inversion function f¹ may be implemented using a look-up table and the corresponding transform may be selected from the look-up table. The GF(16) inversion function f⁻¹ may be similar to the inversion function 215 on FIG. 2.

In operation, the S-box implementation 300 may be utilized for GF(256) inversion transformation during encryption or decryption. The multiplexer 301 may be selected so that both encryption and decryption operation may be handled by the S-box implementation 300. For example, during encryption, the GF(16) inversion logic 302 may return a result 311 by transforming GF(16) to GF(256) and performing an affine transformation. During decryption, the GF(16) inversion logic 302 may return a result 313 by transforming GF(16) to GF(256).

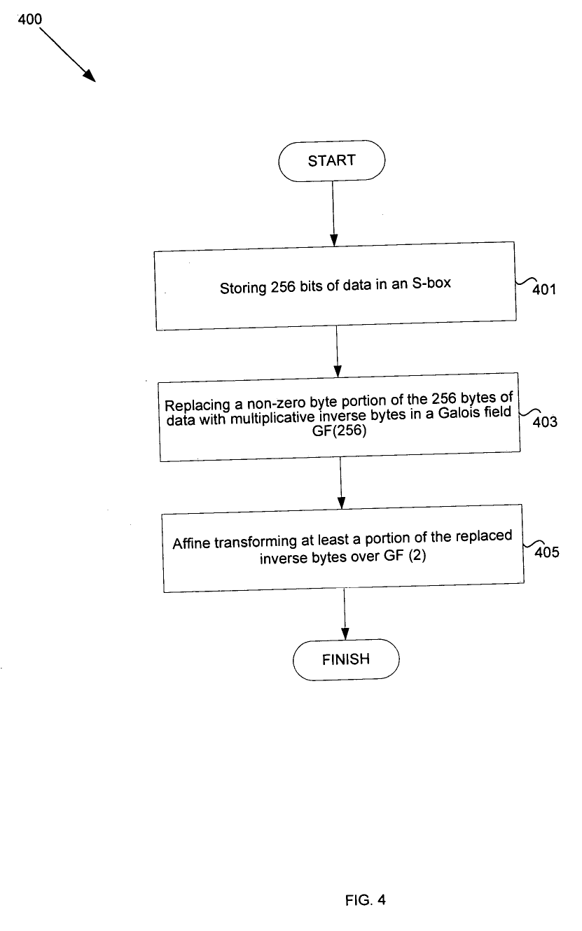

FIG. 4 is a flow diagram of a exemplary method 400 for implementing an S-box, in accordance with an embodiment of the invention. Referring to FIG. 4, at 401, 256 bits of data may be stored in an S-box. At 403, a non-zero byte portion of the stored 256 bits of data may be replaced with multiplicative inverse bytes in GF(256). At 405, the replaced inverse bytes may be affine transformed over GF(2). For example, the affine transformation over GF(2) may be performed by the S-box as a matrix multiplication and addition of (1 1 0 0 0 1 1 0).

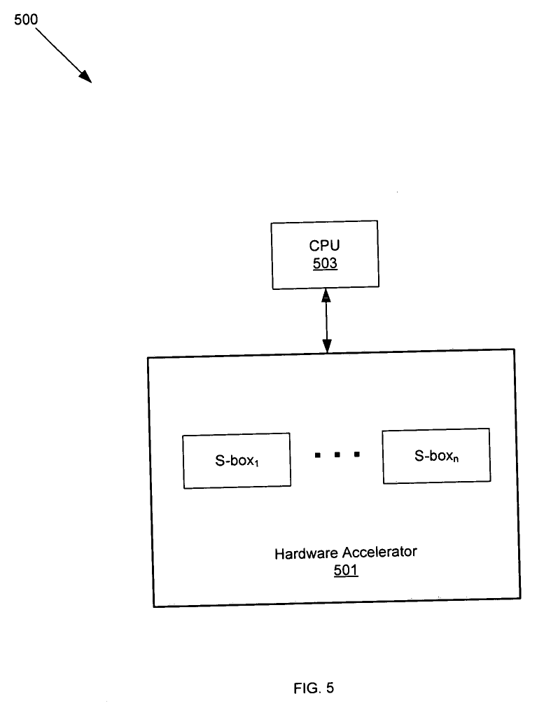

FIG. 5 is a block diagram of a system 500 for AES encryption and decryption utilizing S-boxes, in accordance with an embodiment of the invention. Referring to FIG. 5, the system 500 for AES encryption and decryption may comprise a hardware accelerator 501 and a central processing unit 503. The hardware accelerator 501 may comprise n number of S-boxes, S-box₁ through S-boxₙ, that may be adapted to utilize mathematical equations and perform byte substitution during AES encryption and/or decryption. A more complete description of a hardware accelerator utilizing S-boxes for AES encryption and decryption may be found in U.S. patent application Ser. No. ______ (Attorney Docket # 15598US02), filed Sep. 2, 2004, the subject matter of which is hereby incorporated by reference in its entirety.

Accordingly, aspects of the invention may be realized in hardware, software, firmware or a combination thereof. The invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A system for implementing Advanced Encryption Standard (AES), the system comprising:
circuitry that stores 256 bytes of data; and
said circuitry replacing a non-zero byte portion of said 256 bytes of data with multiplicative inverse bytes in a Galois field GF(256) and affine transforming at least a portion of said replaced inverse bytes over GF (2).

2. The system according to claim 1, wherein said circuitry affine inverse transforms at least a portion of said affine transformed bytes and multiplicatively inverses at least a portion of said affine inverse transformed bytes over GF(256).

3. The system according to claim 1, wherein said circuitry determines said affine transformation over GF(2) as a matrix multiplication and addition of (1 1 0 0 0 1 1 0).

4. The system according to claim 3, wherein said circuitry implements said matrix multiplication and addition using equation:
$$\begin{matrix}y0 \\ y1 \\ y2 \\ y3 \\ y4 \\ y5 \\ y6 \\ y7\end{matrix} = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}x0 \\ x1 \\ x2 \\ x3 \\ x4 \\ x5 \\ x6 \\ x7\end{matrix} ] + [ \begin{matrix}1 \\ 1 \\ 0 \\ 0 \\ 0 \\ 1 \\ 1 \\ 0\end{matrix} ]$$

5. The system according to claim 1, wherein said circuitry maps at least one zero byte from said 256 bytes to said at least one zero byte portion of said 256 bytes of data, if said 256 bytes comprise at least one zero byte.

6. The system according to claim 1, wherein said circuitry replaces said non-zero byte portion of said 256 bytes with multiplicative inverse bytes in said Galois field GF(256) utilizing a first order polynomial (bx+c) with coefficients from GF(16) in optimal normal basis.

7. The system according to claim 1, wherein said circuitry generates said multiplicative inverse bytes in said GF(256) utilizing an irreducible second order polynomial (x²+Ax+B).

8. The system according to claim 7, wherein said circuitry generates said multiplicative inverse bytes in said GF(256) utilizing a first order polynomial (bx+c) modulo said irreducible second order polynomial (x²+Ax+B).

9. The system according to claim 8, wherein said circuitry generates said first order polynomial (bx+c) modulo said irreducible second order polynomial (x²+Ax+B) using equation:
(bx+c)⁻¹=b(b²B+bcA+c²)⁻¹x+(c+bA)(b²B+bcA+c²)⁻¹

10. The system according to claim 1, wherein said circuitry maps a polynomial p(x)=x⁸+x⁴+x³+x²+1 in GF(256) to a first order polynomial with coefficients of GF(16) in optimal normal basis (bx+c).

11. The system according to claim 10, wherein said circuitry maps said polynomial p(x)=x⁸+x⁴+x³+x²+1 in GF(256) to said first order polynomial with coefficients of GF(16) in optimal normal basis (bx+c) utilizing matrices:
$${T}_{γ}^{α} = \begin{matrix}0 & 1 & 0 & 0 & 0 & 1 & 0 & 1 \\ 0 & 0 & 1 & 1 & 1 & 0 & 1 & 1 \\ 1 & 1 & 0 & 0 & 0 & 0 & 0 & 1 \\ 0 & 1 & 0 & 1 & 0 & 1 & 1 & 1 \\ 0 & 1 & 1 & 0 & 1 & 1 & 1 & 1 \\ 0 & 0 & 0 & 0 & 1 & 1 & 1 & 1 \\ 1 & 1 & 0 & 0 & 1 & 0 & 0 & 0\end{matrix} {T}_{α}^{γ} = \begin{matrix}1 & 0 & 0 & 0 & 1 & 1 & 1 & 1 \\ 1 & 1 & 1 & 1 & 1 & 1 & 1 & 0 \\ 1 & 1 & 1 & 1 & 0 & 0 & 1 & 0 \\ 1 & 0 & 0 & 1 & 1 & 0 & 0 & 1 \\ 0 & 1 & 1 & 1 & 0 & 0 & 1 & 1 \\ 0 & 0 & 1 & 0 & 1 & 1 & 1 & 1 \\ 0 & 0 & 0 & 0 & 1 & 0 & 0 & 1\end{matrix}$$

12. The system according to claim 10, wherein said circuitry maps said polynomial p(x)=x⁸+x⁴+x³+x²+1 in GF(256) utilizing look-up table:

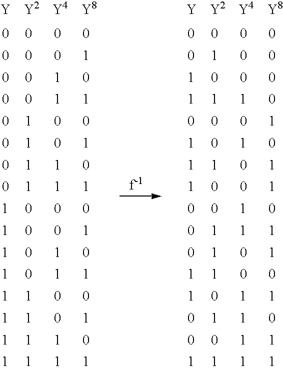

13. A method for implementing Advanced Encryption Standard (AES), the method comprising:
storing 256 bytes of data; and
replacing a non-zero byte portion of said 256 bytes of data with multiplicative inverse bytes in a Galois field GF(256) and affine transforming at least a portion of said replaced inverse bytes over GF (2).

14. The method according to claim 13, further comprising affine inverse transforming at least a portion of said affine transformed bytes and multiplicatively inversing at least a portion of said affine inverse transformed bytes over GF(256).

15. The method according to claim 13, further comprising determining said affine transformation over GF(2) as a matrix multiplication and addition of (1 1 0 0 0 1 1 0).

16. The method according to claim 15, further comprising implementing said matrix multiplication and addition using equation:
$$\begin{matrix}y0 \\ y1 \\ y2 \\ y3 \\ y4 \\ y5 \\ y6 \\ y7\end{matrix} = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}x0 \\ x1 \\ x2 \\ x3 \\ x4 \\ x5 \\ x6 \\ x7\end{matrix} ] + [ \begin{matrix}1 \\ 1 \\ 0 \\ 0 \\ 0 \\ 1 \\ 1 \\ 0\end{matrix} ]$$

17. The method according to claim 13, further comprising mapping at least one zero byte from said 256 bytes to said at least one zero byte portion of said 256 bytes of data, if said 256 bytes comprise at least one zero byte.

18. The method according to claim 13, further comprising replacing said non-zero byte portion of said 256 bytes with multiplicative inverse bytes in said Galois field GF(256) utilizing a first order polynomial (bx+c) with coefficients from GF(16) in optimal normal basis.

19. The method according to claim 13, further comprising generating said multiplicative inverse bytes in said GF(256) utilizing an irreducible second order polynomial (x²+Ax+B).

20. The method according to claim 19, further comprising generating said multiplicative inverse bytes in said GF(256) utilizing a first order polynomial (bx+c) modulo said irreducible second order polynomial (x²+Ax+B).

21. The method according to claim 20, further comprising generating said first order polynomial (bx+c) modulo said irreducible second order polynomial (x²+Ax+B) using equation:
(bx+c)⁻¹=b(b²B+bcA+c²)⁻¹x+(c+bA)(b²B+bcA+c²)⁻¹

22. The method according to claim 13, further comprising mapping a polynomial p(x)=x⁸+x⁴+x³+x²+1 in GF(256) to a first order polynomial with coefficients of GF(16) in optimal normal basis (bx+c).

23. The method according to claim 22, further comprising mapping said polynomial p(x) x⁸+x⁴+x³+x²+1 in GF(256) to said first order polynomial with coefficients of GF(16) in optimal normal basis (bx+c) utilizing matrices:
$${T}_{γ}^{α} = \begin{matrix}0 & 1 & 0 & 0 & 0 & 1 & 0 & 1 \\ 0 & 0 & 1 & 1 & 1 & 0 & 1 & 1 \\ 1 & 1 & 0 & 0 & 0 & 0 & 0 & 1 \\ 0 & 1 & 0 & 1 & 0 & 1 & 1 & 1 \\ 0 & 1 & 1 & 0 & 1 & 1 & 1 & 1 \\ 0 & 0 & 0 & 0 & 1 & 1 & 1 & 1 \\ 1 & 1 & 0 & 0 & 1 & 0 & 0 & 0\end{matrix} {T}_{α}^{γ} = \begin{matrix}1 & 0 & 0 & 0 & 1 & 1 & 1 & 1 \\ 1 & 1 & 1 & 1 & 1 & 1 & 1 & 0 \\ 1 & 1 & 1 & 1 & 0 & 0 & 1 & 0 \\ 1 & 0 & 0 & 1 & 1 & 0 & 0 & 1 \\ 0 & 1 & 1 & 1 & 0 & 0 & 1 & 1 \\ 0 & 0 & 1 & 0 & 1 & 1 & 1 & 1 \\ 0 & 0 & 0 & 0 & 1 & 0 & 0 & 1\end{matrix}$$

24. The method according to claim 22, further comprising mapping polynomial p(x)=x⁸+x⁴+x³+x²+1 in GF(256) utilizing look-up table:

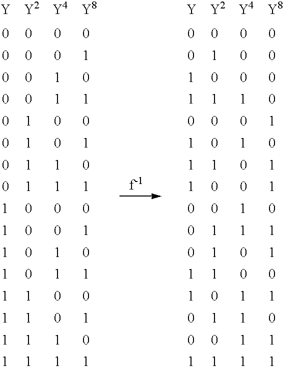

25. A machine-readable storage having stored thereon, a computer program having at least a code section for implementing Advanced Encryption Standard (AES), the at least a code section being executable by a machine to perform steps comprising:
storing 256 bytes of data; and
replacing a non-zero byte portion of said 256 bytes of data with multiplicative inverse bytes in a Galois field GF(256) and affine transforming at least a portion of said replaced inverse bytes over GF (2).

26. The machine-readable storage according to claim 25, further comprising code for affine inverse transforming at least a portion of said affine transformed bytes and multiplicatively inversing at least a portion of said affine inverse transformed bytes over GF(256).

27. The machine-readable storage according to claim 25, further comprising code for determining said affine transformation over GF(2) as a matrix multiplication and addition of (1 1 0 0 0 1 1 0).

28. The machine-readable storage according to claim 27, further comprising code for implementing said matrix multiplication and addition using equation:
$$\begin{matrix}y0 \\ y1 \\ y2 \\ y3 \\ y4 \\ y5 \\ y6 \\ y7\end{matrix} = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}x0 \\ x1 \\ x2 \\ x3 \\ x4 \\ x5 \\ x6 \\ x7\end{matrix} ] + [ \begin{matrix}1 \\ 1 \\ 0 \\ 0 \\ 0 \\ 1 \\ 1 \\ 0\end{matrix} ]$$

29. The machine-readable storage according to claim 25, further comprising code for mapping at least one zero byte from said 256 bytes to said at least one zero byte portion of said 256 bytes of data, if said 256 bytes comprise at least one zero byte.

30. The machine-readable storage according to claim 25, further comprising code for replacing said non-zero byte portion of said 256 bytes with multiplicative inverse bytes in said Galois field GF(256) utilizing a first order polynomial (bx+c) with coefficients from GF(16) in optimal normal basis.

31. The machine-readable storage according to claim 25, further comprising code for generating said multiplicative inverse bytes in said GF(256) utilizing an irreducible second order polynomial (x²+Ax+B).

32. The machine-readable storage according to claim 31, further comprising code for generating said multiplicative inverse bytes in said GF(256) utilizing a first order polynomial (bx+c) modulo said irreducible second order polynomial (x²+Ax+B).

33. The machine-readable storage according to claim 32, further comprising code for generating said first order polynomial (bx+c) modulo said irreducible second order polynomial (x²+Ax+B) using equation:
(bx+c)⁻¹=b(b²B+bcA+c²)⁻¹x+(c+bA)(b²B+bcA+c²)⁻¹

34. The machine-readable storage according to claim 25, further comprising code for mapping a polynomial p(x)=x⁸+x⁴+x³+x²+1 in GF(256) to a first order polynomial with coefficients of GF(16) in optimal normal basis (bx+c).

35. The machine-readable storage according to claim 34, further comprising code for mapping said polynomial p(x)=x⁸+x⁴+x³+x²+1 in GF(256) to said first order polynomial with coefficients of GF(16) in optimal normal basis (bx+c) utilizing matrices:
$${T}_{γ}^{α} = \begin{matrix}0 & 1 & 0 & 0 & 0 & 1 & 0 & 1 \\ 0 & 0 & 1 & 1 & 1 & 0 & 1 & 1 \\ 1 & 1 & 0 & 0 & 0 & 0 & 0 & 1 \\ 0 & 1 & 0 & 1 & 0 & 1 & 1 & 1 \\ 0 & 1 & 1 & 0 & 1 & 1 & 1 & 1 \\ 0 & 0 & 0 & 0 & 1 & 1 & 1 & 1 \\ 1 & 1 & 0 & 0 & 1 & 0 & 0 & 0\end{matrix} {T}_{α}^{γ} = \begin{matrix}1 & 0 & 0 & 0 & 1 & 1 & 1 & 1 \\ 1 & 1 & 1 & 1 & 1 & 1 & 1 & 0 \\ 1 & 1 & 1 & 1 & 0 & 0 & 1 & 0 \\ 1 & 0 & 0 & 1 & 1 & 0 & 0 & 1 \\ 0 & 1 & 1 & 1 & 0 & 0 & 1 & 1 \\ 0 & 0 & 1 & 0 & 1 & 1 & 1 & 1 \\ 0 & 0 & 0 & 0 & 1 & 0 & 0 & 1\end{matrix}$$

36. The machine-readable storage according to claim 34, further comprising code for mapping said polynomial p(x)=x⁸+x⁴+x³+x²+1 in GF(256) utilizing look-up table:

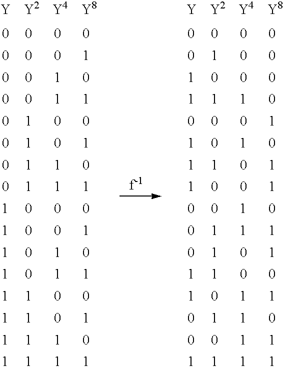

37. A method for implementing Advanced Encryption Standard (AES), the method comprising encrypting data using S-Boxes for byte substitution without utilizing a lookup table, in accordance with AES.

38. The method according to claim 37, further comprising decrypting said encrypted data utilizing said S-Boxes that are used for said encryption without utilizing a lookup table.

39. A system for implementing Advanced Encryption Standard (AES), the system comprising a plurality of S-Boxes that are used for byte substitution while encrypting data in accordance with AES without utilizing a lookup table.

40. The system according to claim 39, wherein said S-Boxes that are utilized for said encryption of said data are used for decryption of said encrypted data, without utilizing a lookup table.
